(19) United States
(12) Patent Application Publication
(10) Pub. No.: US 2007/0084248 A1
(43) Pub. Date: Apr. 19, 2007

(54) Vapor axial deposition apparatus and vapor axial deposition method

(75) Inventors: Jin-Haing Kim, Seoul (KR); Ho-Jin Lee, Suwon-si (KR); Mun-Hyun Do, Chilgok-gun (KR); Jae-Hyeon Seong, Kimcheon-si (KR); Yun-Ho Kim, Daegu (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/516,205

(22) Filed: Sep. 6, 2006

(30) Foreign Application Priority Data
Oct. 19, 2005 (KR) 98699/2005

(51) Int. Cl. C03B 37/07; C03B 37/018; F27B 1/26

(52) U.S. Cl. 65/384; 65/414; 65/488

(57) ABSTRACT

Disclosed is a vapor axial deposition apparatus. The vapor axial deposition apparatus includes a first torch, a second torch, a temperature measuring unit and a controller unit. The first torch deposits soot on a distal end of a soot preform aligned with a vertical axis to thereby grow a core. The second torch deposits soot on an outer circumferential surface of the core to thereby grow a clad. The temperature measuring unit detects the temperature distribution of an end portion of the soot preform along the vertical axis. The controller unit determines first and second relative maximum temperatures T1 and T3, and relative minimum temperature T2 between T1 and T3 in the detected temperature distribution, and controls T1 to be within a predetermined range and the greater one of the difference (T1−T2) and (T3−T2) to not exceed a predetermined temperature.

### RELATED APPLICATION

This application is related to that patent application entitled “Vapor Axial Deposition Apparatus and Vapor Axial Deposition Method,” filed on Jul. 17, 2006 and afforded Ser. No. 11/487,846, by the US Patent and Trademark Office, which claims the benefit of the earlier filing date to that patent application filed in the Korean Industrial Property Office on Sep. 16, 2005, and assigned Serial No. 2005-86898, the contents of which are hereby incorporated by reference.

### CLAIM OF PRIORITY

This application claims the benefit of the earlier filing date, pursuant to 35 USC 119, to that patent application entitled “Vapor Axial Deposition Apparatus and Vapor Axial Deposition Method,” filed in the Korean Intellectual Property Office on Oct. 19, 2005, and assigned Serial No. 2005-98699, the contents of which are hereby incorporated by reference.

### BACKGROUND OF THE INVENTION

1. Field of the Invention

The present invention relates to an apparatus and a method for manufacturing optical fiber preforms, and more particularly to a vapor axial deposition (VAD) apparatus and a vapor axial deposition method.

2. Description of the Related Art

A vapor axial deposition method is a method for obtaining a soot preform by depositing soot on a starting rod made of glass material by means of first and second torches to grow a core and a clad in a longitudinal direction. Subsequently, the soot preform is subjected to a sintering process, etc. to obtain an optical fiber preform.

U.S. Pat. No. 6,834,516, entitled “Manufacture of Optical Fiber Preforms Using Modified VAD” and granted to Donald P. Jablonowski et al., discloses a vapor axial deposition method for obtaining a soot preform having uniform composition by measuring the temperature of a distal end of the soot preform by means of an optical pyrometer to adjust a flow rate of hydrogen gas with which a core torch is provided.

However, such a vapor axial deposition method has the following problems:

Firstly, since one point on a distal end of a soot preform is monitored using an optical pyrometer disposed below the soot preform, it is difficult to maintain a focus due to the rotation and the vibration of the soot preform.

Secondly, since soot and a flame exist between the distal end of the soot preform and the optical pyrometer, a lot of noise is included in measurement values of the optical pyrometer due to interferences by the soot and the flame.

Thus, the vapor axial deposition method as stated above has a problem in that its mass productivity and reliability deteriorates because precise temperature measurement and control for the distal end of the soot preform are difficult.

The above-mentioned vapor axial deposition method has another problem in that only the temperature of the distal end of the soot preform is measured, and thus the overall temperature distribution of an end portion of the soot preform and the quality of the soot preform according to the aspects of the temperature distribution are not sufficiently considered.

Therefore, there is a desire to develop a vapor axial deposition apparatus and a vapor axial deposition method, which can improve the quality of the soot preform in consideration of the overall temperature distribution of the end portion of the soot preform, and have high mass productivity and reliability.

### SUMMARY OF THE INVENTION

Accordingly, the present invention has been made to solve at least the above-mentioned problems occurring in the prior art and provides additional advantages, by providing a vapor axial deposition apparatus and a vapor axial deposition method, which can improve the quality of a soot preform in consideration of the overall temperature distribution of an end portion of the soot preform, and have high mass productivity and reliability.

In accordance with one aspect of the present invention, there is provided a vapor axial deposition apparatus comprising a first torch for depositing soot on a distal end of a soot preform aligned with a vertical axis to thereby grow a core, a second torch for depositing soot on an outer circumferential surface of the core to thereby grow a clad, a temperature measuring unit for detecting a temperature distribution of an end portion of the soot preform along the vertical axis, and a controller unit for determining first and second relative maximum temperatures T1 and T3, and relative minimum temperature T2 between T1 and T3 in the detected temperature distribution, and controlling T1 and ΔT, that is, (T1−T2) or (T3−T2).

In accordance with another aspect of the present invention, there is provided a vapor axial deposition method, in which soot is deposited on a soot preform aligned with a vertical axis by using first and second torches, the method comprising the steps of (a) detecting a temperature distribution of an end portion of the soot preform along the vertical axis, (b) determining first and second relative maximum temperatures T1 and T3, and relative minimum temperature T2 between T1 and T3 in the detected temperature distribution, (c) adjusting the quantity of raw materials supplied to the first torch such that T1 lies in a predetermined temperature range, and (d) adjusting a distance between a flame focus of the first torch and a flame focus of the second torch such that one of (T1−T2) and (T3−T2), which has a greater value than the other, becomes equal to or less than a predetermined temperature value.

### BRIEF DESCRIPTION OF THE DRAWINGS

The above features and advantages of the present invention will be more apparent from the following detailed description taken in conjunction with the accompanying drawings, in which:

FIG. 1 is a view illustrating a vapor axial deposition apparatus in accordance with a preferred embodiment of the present invention;

FIG. 2 is a view illustrating a thermal image detected by a temperature measuring unit shown in FIG. 1; and

FIG. 3 is a graph illustrating a temperature distribution of an end portion of a soot preform along a vertical axis shown in FIG. 1.

### DETAILED DESCRIPTION OF THE INVENTION

Hereinafter, embodiments of the present invention will be described with reference to the accompanying drawings. It should be noted that the similar components are designated by similar reference numerals although they are illustrated in different drawings. For the purposes of clarity and simplicity, a detailed description of known functions and configurations incorporated herein will be omitted when it may obscure the subject matter of the present invention.

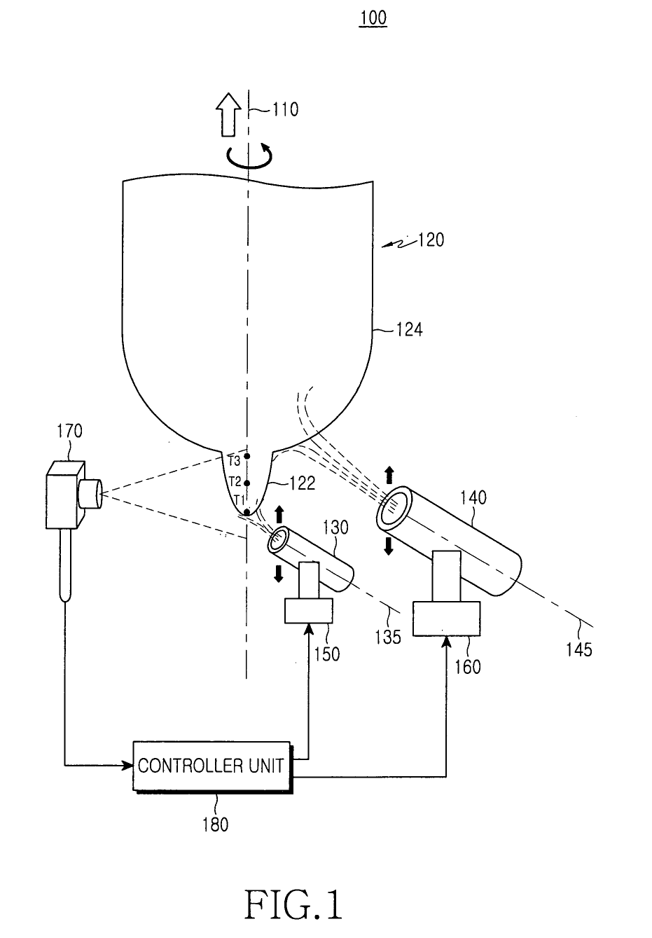

FIG. 1 illustrates a vapor axial deposition apparatus according to an embodiment of the present invention. The vapor axial deposition apparatus 100 includes first and second torches 130, 140 for creating and depositing soot, first and second stages 150, 160 for inclining the first and second torches, respectively, a temperature measuring unit 170 for detecting the temperature distribution of an end portion of a soot preform along a vertical axis 110, and a controller unit 180 for controlling the first and second torches 130, 140.

A soot preform 120 is aligned with the vertical axis 110, and includes a starting rod made of glass material for providing a growth base, and a core 122 and a clad 124 formed by depositing soot on an end of the starting rod. The core 122 has a relatively high refractive index, and the clad 124 surrounding the core 122 has a relatively low refractive index. In an initial period of the soot deposition, soot is deposited on the end of the starting rod by using the second torch 140 to form a ball. When the ball reaches predetermined size by further depositing soot, the core 122 and the clad 124 are simultaneously formed on the ball by using the first and second torches 130, 140. In a case where the core and the clad are grown directly on the end of the stating rod without forming the ball, the soot preform 120 may be separated from the starting rod or cracks may occur in the soot preform 120 due to the weight of the soot preform 120.

During the soot deposition, the soot preform 120 rotates and moves upward at predetermined speeds. By rotating the soot preform about the vertical axis 110, the soot preform 120 has rotational symmetry. Also, by moving the soot preform 120 upward along the vertical axis 110, the soot preform continuously grows downward along the vertical axis 110. Hereinafter, with respect to the vertical axis 110, the growing direction of the soot preform 120 will be referred to as “downward”, and an opposite direction thereof will be referred to as “upward”.

The first torch 130, positioned along a central axis 135, which is inclined at an acute angle to the vertical axis 110, emits a flame toward a distal end of the soot preform 120 to grow the core 122 downward from the distal end of the soot preform 120. The first torch 130 is provided with glass raw material, such as SiCl₄, GeCl₄, etc., and a fuel material, for example, a mixture of hydrogen and oxygen. As the glass raw material is dehydrated within the emitted flame, soot is produced, and the produced soot is deposited on the soot preform 120. Dehydration formulas of SiO₂ and GeO₂, main oxides constituting the soot, are as follows:
SiCi₄+2H₂O→SiO₂+4HCl (1)
GeCl₄+2H₂O→GeO₂+4HCl (2)

The second torch 140 is spaced upward from the first torch 130, and is positioned along a central axis 145 that inclined at an acute angle to the vertical axis 110. The second torch 140 emits a flame toward an outer circumferential surface of the core 122 to grow the clad 124 on the outer circumferential surface of the core 122. The second torch 140 is provided with glass raw material, such as SiCl₄, GeCl₄, etc., and hydrogen and oxygen constituting fuel material. As the glass raw material is dehydrated within the emitted flame, soot is produced, and the produced soot is deposited on the soot preform 120.

By controlling different kinds of glass materials provided to the first and second torches 130, 140 or the flow rate of the glass material provided to the first torch 130, which may be different from the flow rate of the glass material provided to the second torch 140, the core 122 can have a greater refractive index than that of the clad 124. For example, germanium and phosphorus increase the refractive index, whereas boron decreases the refractive index.

Optical characteristics (dispersion, macrobend loss, etc.) of an optical fiber obtained from the soot preform 120 are influenced by the overall surface temperature of a portion on which the soot is deposited (that is, an end portion of the soot preform 120), including distal end temperature of the soot preform 120.

The first stage 150 inclines the first torch 130 under the control of the controller unit 180 to adjust an inclined angle of the first torch 130 with respect to the vertical axis 110. For example, the first torch 130 has a rotation axis perpendicular to its central axis 135, and the first stage 150 can incline the first torch 130 by rotating the first torch 130 about the rotation axis.

In addition, the first stage 150 may move the first torch 130 upward or downward with or without the first torch 130 being inclined.

The second stage 160 inclines the second torch 140 under the control of the controller unit 180 to adjust an inclined angle of the second torch 140 with respect to the vertical axis 110. For example, the second torch 140 has a rotation axis perpendicular to its central axis 145, and the second stage 160 can incline the second torch 140 by rotating the second torch 140 about the rotation axis.

In addition, the second stage 160 may move the second torch 140 upward or downward with or without inclining second torch 140.

The temperature measuring unit 170 is disposed on a side of the soot preform 120, which detects a thermal image of the end portion of the soot preform 120, and outputs the detected thermal image signal to the controller unit 180. The thermal image signal includes information on the temperature distribution of the end portion of the soot preform 120. Also, the end portion of the soot preform 120 includes a portion on which soot is deposited, that is, an exposed core portion 122 at the distal end of the soot perform 120, and a boundary portion between the core 122 and the clad 124 along the vertical axis 110. A common thermal imager may be used as the temperature measuring unit 170.

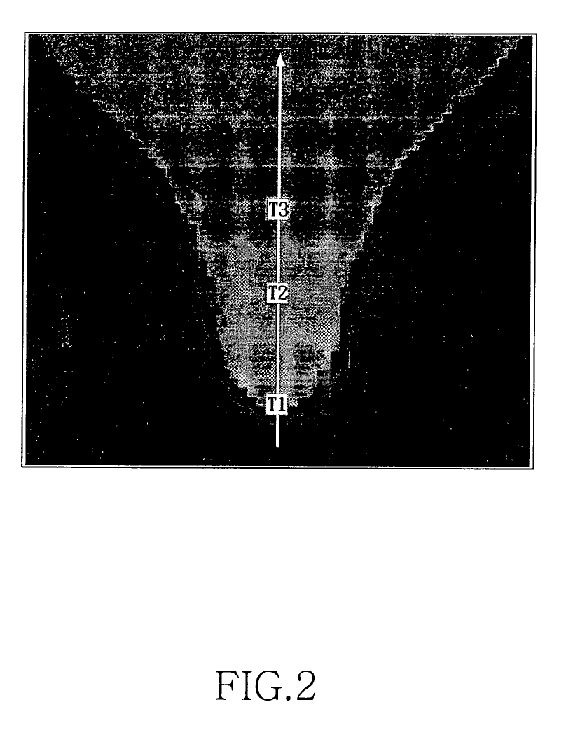

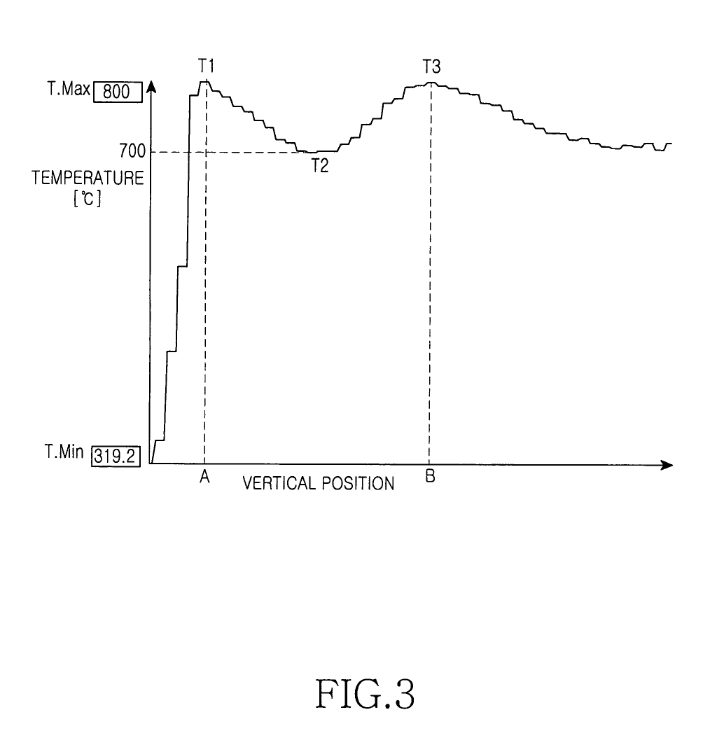

FIG. 2 illustrates a thermal image detected by the temperature measuring unit 170, and FIG. 3 illustrates a temperature distribution of the end portion of the soot preform 120.

In FIG. 2, an upward direction (designated by an arrow), a first relative maximum temperature T1, a relative minimum temperature T2 and a second maximum temperature T3 are depicted. In FIG. 3, the ordinate axis indicates surface temperature, and the abscissa axis indicates a position on the vertical axis 110, that is, a vertical position.

As illustrated in these drawings, the first relative maximum temperature T1 appears at the distal end A of the soot preform 120, the second relative maximum temperature T3 appears in the boundary portion B between the core 122 and the clad 124 along the vertical axis 110, and the relative minimum temperature T2 appears at an intermediate position between the distal end A of the soot preform 120 and the boundary portion B. This is because the flame focus, (i.e., a point at which a flame of the torch converges) of the first torch 130 is located at the distal end A of the soot preform 120, and a flame focus of the second torch 140 is located in the boundary portion B.

The first relative maximum temperature T1 can be controlled by regulating the flow rate of fuel material supplied to the first torch 130, and the second relative maximum temperature T3 can be controlled by regulating the flow rate of fuel material supplied to the second torch 140. Preferably, the first relative maximum temperature T1 lies in a range of 750 to 850 degrees Centigrade (° C.), and the second relative maximum temperature T3 lies in a range of 740 to 840° C.

Referring to FIG. 3, the first and second relative maximum temperatures T1 and T3 are 800° C., respectively, and the relative minimum temperature T2 is 700° C.

From the following description of several experimental examples, it can be seen that the smaller a temperature difference between the first relative maximum temperature T1 and the relative minimum temperature T2 or a temperature difference between the second relative maximum temperature T3 and the relative minimum temperature T2, the more optical characteristics are improved.

TABLE 1

| | | optical characteristics | | |
|---|---|---|---|---|
| | | | | macrobend |
| | process | zero | | loss [dB] |
| | condition | dispersion | dispersion | @100T, |
| | ΔT | wavelength | slope (S₀) | R = 30 mm, |
| | [° C.] | (λ₀) [nm] | [ps/nm ² · km] | 1625 nm |
| optical fiber | — | 1300˜1324 | ≦0.093 | ≦0.50 |
| ITU-T G652D | | | | |
| first example | <60 | 1310˜1315 | ˜0.086 | <<0.50 |
| second | 60˜120 | 1310˜1315 | 0.086˜0.090 | <<0.50 |
| example | | | | |
| third | 120˜200 | 1315˜1324 | 0.090˜0.093 | <0.50 |
| example | | | | |
| fourth | >200 | >1324 | >0.093 | >0.50 |
| example | | | | |

In Table 1, optical characteristics for optical fiber ITU-T G652D as a target and optical characteristics for first to fourth experimental examples are listed. The first and fourth examples are experimented with optical fibers drawn from an optical fiber perform, which is produced by the vapor axial deposition method. In Table 1, ΔT represents a temperature difference between the first relative maximum temperature T1 and the relative minimum temperature T2 ((T1−T2)) or a temperature difference (between the second relative maximum temperature T3 and the relative minimum temperature T2 (T3−T2)). For the respective examples, values of a zero dispersion wavelengths λ₀ and a dispersion slope S₀ at the zero dispersion wavelength λ₀ are presented in Table 1. Macrobend loss is obtained in such a manner that light having a wavelength of 1625 nm is incident into one end of an optical fiber in a state where the corresponding optical fiber is wound around a spool 100 times, and the power of the light is measured at the other end of the optical fiber.

It can be seen from Table 1 that the temperature difference ΔT must be equal to or less than 200° C. in order to satisfy the conditions of the optical fiber ITU-T G652D.

The controller unit 180 determines a surface temperature distribution of the end portion of the soot perform 120 along the vertical axis 110 from the thermal image signal which the temperature measuring unit 170 inputs thereto. Also, in this temperature distribution, the controller unit 180 captures the first and second relative maximum temperatures T1 and T3, and the relative minimum temperature T2 between T1 and T3. The controller unit 180 adjusts a distance between the flame focuses of the first and second torches 130, 140 such that the greater one of (T1−T2) and (T3−T2) becomes less than or equal to (i.e., does not exceed) a predetermined temperature value. For example, if either (T1−T2) or (T3−T1) is greater than 200° C., the controller unit 180 may move the flame focus of the second torch 140 upward. To this end, the controller unit 180 drives the second stage 160 to incline the second torch 140 toward a direction in which the central axis 145 of the second torch 140 becomes perpendicular to the vertical axis 110 (that, is a direction in which the inclined angle of the second torch 140 becomes wider). Consequently, the relative minimum temperature T2, resulting from interferences of the first and second torches 130, 140, grows higher than the previous temperature.

In addition, the controller unit 180 controls the first relative maximum temperature T1 to be in a range of 750 to 850° C., and preferably maintains a region, located within 5 mm above the flame focus of the first torch 130, in a range of 750 to 850° C. To this end, the controller unit 180 may adjust the quantity of fuel material supplied to the first torch 130 or adjust both the quantities of fuel material supplied to the first and second torches 130, 140.

In another aspect, to satisfy the conditions of the optical fiber ITU-T G652D, the controller unit 180 controls T1 to be in a range of 750 to 850° C., and controls one of (T1−T2) and (T3−T2), which has a greater value than the other, to become equal to or less than 200° C.

As described above, according to a vapor axial deposition apparatus and a vapor axial deposition method of the present invention, the overall temperature distribution of an end portion of a soot preform is detected using a temperature measuring unit, and a relative maximum temperature and a temperature difference between a first relative maximum temperature and relative minimum temperature or a temperature difference between second relative maximum temperature and the relative minimum temperature are controlled, through which the quality of the soot preform and the optical characteristics of optical fibers obtained from the soot preform can be improved, and mass productivity and reliability of the soot preform can be enhanced.

The method for implementing processing shown herein according to the present invention can be stored in a computer-readable form in a recording medium (such as a CD ROM, RAM, floppy disk, hard disk or magneto-optical disk). It would be recognized that the apparatus may include a processor that receives and executes a computer program or a computer-executable code, which may be stored in a memory.

While the invention has been shown and described with reference to certain preferred embodiments thereof, it will be understood by those skilled in the art that various changes in form and details may be made therein without departing from the spirit and scope of the invention as defined by the appended claims and equivalents thereof.

What is claimed is:

1. A vapor axial deposition apparatus comprising:
a first torch for depositing soot on a distal end of a soot preform aligned with a vertical axis to thereby grow a core;
a second torch for depositing soot on an outer circumferential surface of the core to thereby grow a clad;
a temperature measuring unit for detecting a temperature distribution of an end portion of the soot preform along the vertical axis; and
a controller unit for determining first and second relative maximum temperatures T1 and T3, and relative minimum temperature T2 between T1 and T3 in the detected temperature distribution, and controlling the relative maximum value (T1) and a difference (ΔT), selected from the group consisting of: (T1−T2) and (T3−T2).

2. The apparatus as claimed in claim 1, wherein the controller unit controls first relative temperature (T1) to be within a first predetermined temperature range, and controls the greater of the differences (T1−T2) and (T3−T2) to not exceed a predetermined temperature value.

3. The apparatus as claimed in claim 2, wherein the controller unit adjusts the quantity of fuel material supplied to the first torch such that T1 lies in the first predetermined temperature range.

4. The apparatus as claimed in claim 2, wherein the controller unit adjusts a distance between flame focuses of the first and second torches.

5. The apparatus as claimed in claim 1, wherein if the greater one of the differences (T1−T2) and (T3−T2) exceeds the predetermined temperature value, the controller expands the distance between the flame focuses of the first and second torches.

6. The apparatus as claimed in claim 5, further comprising a stage for adjusting an inclined angle of the second torch under the control of the controller unit, wherein the controller unit narrows the inclined angle of the second torch if the greater one of the differences (T1−T2) and (T3−T2) exceeds the predetermined temperature value.

7. The apparatus as claimed in claim 2, wherein the first predetermined temperature range is between 750 and 850° C.

8. The apparatus as claimed in claim 2, wherein the predetermined temperature value is at least 200° C.

9. A vapor axial deposition method, in which soot is deposited on a soot preform aligned with a vertical axis by using first and second torches, the method comprising the steps of:
(a) detecting a temperature distribution of an end portion of the soot preform along the vertical axis;
(b) determining first and second relative maximum temperatures T1 and T3, and relative minimum temperature T2 between T1 and T3 in the detected temperature distribution;
(c) adjusting the quantity of raw materials supplied to the first torch such that T1 lies in a predetermined temperature range; and
(d) adjusting a distance between a flame focus of the first torch and a flame focus of the second torch such that the greater one of the differences (T1−T2) and (T3−T2) does not exceed a predetermined temperature value.

10. The method as claimed in claim 9, the predetermined temperature range is between 750 and 850° C.

11. The method as claimed in claim 9, the predetermined temperature value is at least 200° C.

12. An optical fiber fabrication apparatus comprising:
first and second means for depositing a soot preform aligned with a vertical axis;
means for monitoring a temperature distribution of an end portion of the soot preform along the vertical axis, the distribution including first and second relative maximum temperatures T1 and T3, and relative minimum temperature T2 between T1 and T3; and
means for maintaining the first relative temperature within a predetermined temperature range and the greater one of the differences (T1−T2) and (T3−T2) to not exceed a predetermined temperature value.

13. The apparatus according to claim 12, wherein the predetermined temperature value is at least 200° C.

14. The apparatus according to claim 12, wherein the predetermined temperature range is between 750 and 850° C.

15. The apparatus according to claim 12, wherein the predetermined temperature value is selected based on a desired wavelength characteristic.

16. The apparatus according to claim 12, wherein the first relative temperature and predetermined temperature value are maintained by adjusting the first and second depositing means laterally and vertically from the soot perform.

17. The apparatus according to claim 12, wherein the first relative temperature and predetermined temperature value are maintained by adjusting an angle of inclination of the first and second depositing means with regard to the soot perform.

18. The apparatus according to claim 12, wherein the first and second depositing means is provided a glass raw material and a mixture of hydrogen and oxygen.
